(19) United States
(12) Patent Application Publication
(10) Pub. No.: US 2006/0091571 A1
(43) Pub. Date: May 4, 2006

(54) Method for fabricating polymer optical waveguide device

(75) Inventors: Eiichi Akutsu, Ashigarakami-gun (JP); Shigemi Ohtsu, Ashigarakami-gun (JP); Keishi Shimizu, Ashigarakami-gun (JP); Kazutoshi Yatsuda, Ashigarakami-gun (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/127,242

(22) Filed: May 12, 2005

(30) Foreign Application Priority Data
Oct. 29, 2004 (JP) 2004-315758

(51) Int. Cl. B29D 11/00

(52) U.S. Cl. 264/1.24

(57) ABSTRACT

The present invention provides a method for fabricating a polymer optical waveguide device, the method at least includes: preparing a mold including a cured resin layer of a mold forming curing resin and having a concave portion correspondent to a core portion of an optical waveguide formed therein; attaching the mold to a cladding base material; filling the concave portion of the mold with a core forming curing resin; hardening the core forming curing resin to form a cured core portion; forming a space or a groove for placing an optical device in a middle part in the waveguide direction of the core portion such that the optical device cuts across the core portion; inserting and positioning the optical device in a predetermined position of the space or groove; and conducting an optical bonding between an optical pathway portion of the optical device and the core portion.

### CROSS-REFERENCE TO RELATED APPLICATION

This application claims priority under 35 USC 119 from Japanese Patent Application No. 2004-315758, the disclosure of which is incorporated by reference herein.

### BACKGROUND OF THE INVENTION

1. Field of Invention

The present invention relates to a method for fabricating a polymer optical waveguide device provided with an optical device.

2. Description of the Related Art

The methods for producing polymer waveguides that have been proposed include, for example, (1) a method that involves impregnating films with a monomer, selectively exposing the core portion to light to change the refractive index of the core portion, and then bonding the films together (selective polymerization); (2) a method that involves molding a core layer and a cladding layer by coating and subsequently forming a cladding portion by means of reactive ion etching (RIE method); (3) a method that involves adding a photosensitive material to a polymer material to produce an ultraviolet curing resin, and then light exposing the resin and developing by photolithography (direct exposure method); (4) a method utilizing injection molding; and (5) application of a method that involves molding a core layer and a cladding layer by coating and then exposing a portion to be the core portion to light to change the refractive index of the core portion (photobreaching), or the like.

However, selective polymerization as in (1) above poses a problem in bonding films together. The methods of (2) and (3) increase production costs due to the use of photolithography. The method of (4) causes a problem in precision of a resultant core diameter. The method of (5) presents a problem in that the method cannot produce a sufficient refractive index difference between the core portion and the cladding layer. At present, examples of practical methods that are excellent in performance of the waveguide include only the methods of (2) and (3); however, they pose problems in production costs as noted supra. Further, all methods (1) to (5) are difficult to apply to the formation of polymer waveguides in a plastic base material that has a large area and is flexible.

Additionally, methods for producing polymer optical waveguides also include a method that involves forming the pattern of a groove to be a capillary in a pattern base material (a cladding), filling a polymer precursor material for the core therein, hardening the material to fabricate the core layer, and subsequently bonding a flat base material (a cladding) thereon. In this method, however, it is not only the capillary grooves that are filled by the polymer precursor material: the polymer precursor material is thinly filled into the entire area between the pattern base material and the flat base material where it hardens, forming a thin layer having the same composition as the core layer. This presents a problem in that light leaks through this thin layer.

As a method of solving the above problem, David Hart has proposed a method that involves pinching a pattern base material and a flat base material, in which the pattern of a groove to be a capillary is formed, by means of a jig for clamping, sealing the contact portion of the pattern base material and the flat base material using a resin or the like, and then filling a monomer (diallylisophthalate) solution for the core in the capillaries under a reduced pressure to produce a polymer optical waveguide (refer to, for example, U.S. Pat. No. 3,151,364). This method makes use of the monomer as a core forming resin material in place of a polymer precursor in order to decrease the viscosity of the filling material, and the monomer is filled into the capillaries by use of capillary action such that the monomer is filled in the capillaries alone.

Recently, George M. Whitesides et al., Harvard University, have proposed capillary micromolding, which is classified as a soft lithographic technique, as a novel technique of producing a nanostructure. This is a method that involves fabricating a master base material making use of photolithography, utilizing adhesion properties and easy release of polydimethylsiloxane (PDMS) to copy the nanostructure of a master base material into a mold of PDMS, and casting the liquid polymer into the mold by use of capillary action and hardening (refer to, for example, SCIENTIFIC AMERICAN September 2001). A patent application for capillary micromolding is disclosed by Kim Enoch et al., of the group of George M. Whitesides, Harvard University (refer to, for example, U.S. Pat. No. 6,355,198).

Further, B. Michel et al. of the IBM Zurich Laboratory have proposed a lithography technology having high resolution using PDMS, and report the attainment of a resolution of tens of nanometers by use of the technology (refer to, for example, IBM J. REV. & DEV. VOL. 45 NO. 5 September 2001).

As described supra, soft lithography and capillary micromolding, using PDMS, are technologies that have recently received attention as nanotechnologies primarily in the US.

The present inventors have already proposed methods of solving a variety of problems in the micromolding described above, by placing a cladding base material on top of a flexible film base material, and fabricating a polymer optical waveguide in the film base material (refer to, for example, Japanese Patent Application Laid-Open (JP-A) Nos. 2004-226941 and 2004-86144). The method of producing this polymer optical waveguide has enabled a precise, low-cost fabrication of a flexible polymer optical waveguide, which was previously not possible.

In IC and LSI technologies, attention has recently been paid to the use of optical wiring between apparatuses, between boards in apparatuses, and within chips, instead of metal wiring, in order to control signal delay and noise and to improve the degree of integration. For example, light emitting devices and light receiving devices are connected by optical waveguides. (Refer to, for example, JP-A Nos. 2000-39530, 2000-39531 and 2000-235127.)

The optical wiring device described in JP-A No. 2000-39530 has an incidence side mirror that causes the light from a light emitting device to enter the core and an outgoing radiation side mirror that causes the light to be emitted from the core to a light receiving device, and a concave shaped cladding layer is formed at a site corresponding to a optical pathway from the light emitting device to the incidence side mirror and from the outgoing radiation side mirror to the light receiving device, which converges the light from the light emitting device and the light from the outgoing radiation side mirror. The light wiring device described in JP-A No. 2000-39531 is formed in such a way that the incidence end surface of the core becomes a concave face that faces toward the light emitting device, and converges the light from the light emitting device to supress waveguide loss. The light wiring devices described in JP-A Nos. 2000-39530 and 2000-39531 have complex constructions, and thus their fabrication requires very complicated processes.

JP-A No. 2000-235127 discloses an optoelectronic integrated circuit in which a polymer optical waveguide circuit is directly patterned on top of a photoelectric fusion circuit produced by integrating electronic devices and optical devices; however, photolithography, which is costly, is used for the fabrication of the polymer optical waveguide. Hence, the optoelectronic integrated circuit is inevitably high-priced.

To solve these problems, the inventors have proposed an optical device that can be fabricated inexpensively by a method that directly includes a luminous component or further includes a light-sensitive component, on the core end surface of the polymer optical waveguide, and includes an uncomplicated, extremely simplified construction (refer to, for example, JP-A No. 2004-29507).

However, for easy, inexpensive fabrication of the above optical wiring device supra and photoelectric integrated circuit, a technology for manufacturing an optical waveguide device that also inserts an optical device somewhere into the fabricated optical waveguide highly precisely and with a low loss is additionally required. In this respect, conventional inorganic type optical waveguides pose many problems in that the loss of light is large due to the insertion of an optical device.

### SUMMARY OF THE INVENTION

In consideration of the above requirements the present invention provides a method for producing a high density polymer optical waveguide device having an optical device inserted into the optical waveguide thereof simply and highly precisely, and exhibiting a low loss of light.

The above problems supra are solved by the provision of a method for producing a polymer optical waveguide device having an optical device as described below.

Namely, the present invention provides a method for fabricating a polymer optical waveguide device, the method at least includes: preparing a mold including a cured resin layer of a mold forming curing resin and having a concave portion correspondent to a core portion of an optical waveguide formed therein; attaching the mold to a cladding base material; filling the concave portion of the mold with a core forming curing resin; hardening the core forming curing resin to form a cured core portion; forming a space or a groove for placing an optical device in a middle part in the waveguide direction of the core portion such that the optical device cuts across the core portion; inserting and positioning the optical device in a predetermined position of the space or groove; and conducting an optical bonding between an optical pathway portion of the optical device and the core portion.

In a polymer optical waveguide device fabricated according to the invention, the polymer optical waveguide may be formed on the cladding base material in advance, and an optical device is inserted into an optical device inserting portion (space, groove) that is formed in the highly precise optical waveguide in advance, a predetermined optical adhesive is incorporated into the optical pathway between the waveguide (core portion) on the waveguide base material and the optical device, and the adhesive is optically hardened, thereby enabling simple fabrication of a highly functional optical circuit base material. In addition, each electronic device can also be placed on the surface of the optical circuit base material in close proximity, whereby a photoelectric consolidation type circuit base material, in which optical and electronic devices are consolidated with a low loss of light and highly densely, can readily be fabricated.

In particular, causing the properties (hardness, material, thickness, surface energy, surface smoothness) of a hardened resin layer, which is a mold, to be in a constant range enables easy attainment of a high quality waveguide at a low cost. Additionally, the shape of an optical waveguide to be formed can be freely designed, thereby achieving optical properties of extremely precise shape reproduction and low loss wave guiding, despite the manufacturing process being easy and simple. Moreover, a variety of optical devices can freely and easily be attached, providing with great precision a fundamental form of a highly functional optical circuit base material.

### BRIEF DESCRIPTION OF THE DRAWINGS

Preferable embodiments of the present invention will be described in detail based on the following figures, wherein,

FIGS. 1A, 1B, 1C, 1D, 1E, 1F, and 1G are conceptual diagrams of an example of the production of a polymer optical waveguide;

FIG. 2 is a perspective view indicating a state in which a mold is attached to a cladding base material;

FIGS. 3A, 3B, 3C, 3D, 3E, 3F, and 3G are conceptual diagrams of an example of the production of a polymer optical waveguide;

FIGS. 4A and 4B are conceptual diagrams depicting a core material filling process that uses a mold equipped with a reinforcing member;

FIGS. 5A and 5B are conceptual diagrams depicting another core material filling process that uses a mold equipped with a reinforcing member;

FIGS. 6A, 6B, 6C, and 6D are conceptual diagrams of an example of a method for producing a polymer optical waveguide device of the invention;

FIGS. 7A, 7B, 7C, and 7D are conceptual diagrams of another example of a method for producing a polymer optical waveguide device of the invention; and

FIGS. 8A and 8B are conceptual diagrams of an example indicating an optical device optically bonded to a waveguide base material.

### DETAILED DESCRIPTION OF THE INVENTION

The present invention will be set forth in detail hereinafter.

A method for producing a polymer optical waveguide device of the invention includes at least (1) to (7) infra:

(1) Preparing a mold that includes a cured resin layer of a mold forming curing resin and has a concave portion correspondent to a core portion of the optical waveguide formed therein.

(2) Attaching the mold to a cladding base material.

(3) Filling the concave portion of the mold with a core forming curing resin.

(4) Hardening the core forming curing resin to form a cured core portion.

(5) Forming a space or a groove for placing an optical device in the middle part in a waveguide direction of the core portion such that the optical device cuts across the core portion.

(6) Inserting and positioning the optical device in a predetermined position of the space or groove.

(7) Conducting an optical bonding between the optical pathway portion of the optical device and the core portion.

A method for producing a polymer optical waveguide device of the invention may include at least (1) to (7) supra and may also include processes in addition thereto. An aspect of a method for producing a polymer optical waveguide device of the invention will be described below.

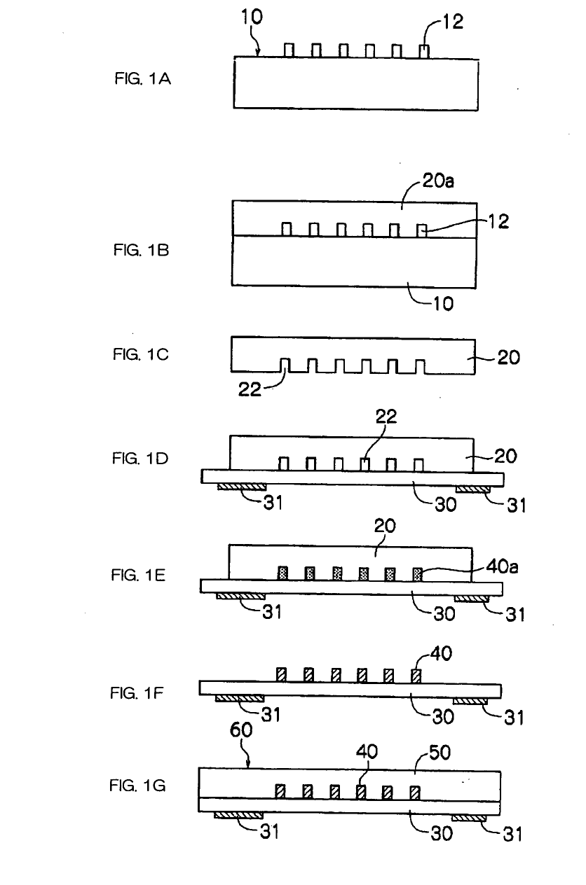

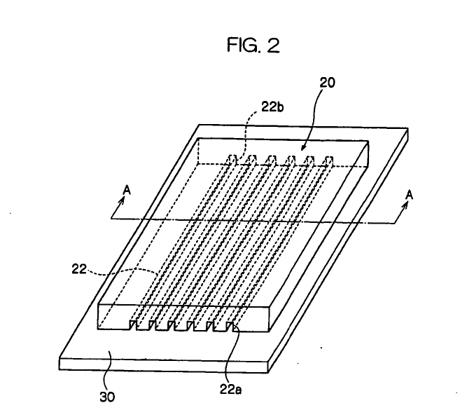

First, the processes of producing a polymer optical waveguide according to the invention will be briefly set forth with reference to FIGS. 1 to 3. FIGS. 1A to 1G are conceptual diagrams indicating each process of the production of the polymer optical waveguide. FIG. 2 is a perspective view indicating a state in which a mold is attached to a cladding base material that has a surface area larger than the mold.

FIG. 1A is a cross section view of a matrix 10 on which convex portions 12 corresponding to the core portion of the optical waveguide are formed, viewed at a right angle to the longitudinal direction of the convex portions 12.

Next, a cured resin layer 20a of a mold forming curing resin is formed on the surface of the matrix 10 on which the convex portions 12 are formed, as shown in FIG. 1B. FIG 1B is a cross section view of the matrix 10 with the cured resin layer 20a of the mold forming curing resin formed thereon, viewed at a right angle to the longitudinal direction of the convex portions 12.

Next, the cured resin layer 20a of the mold forming curing resin is released from the matrix 10 to take the mold out (not shown), and both ends of the mold are cut so as to expose concave portions 22 to form entry portions 22a (refer to FIG. 2) for filling the concave portions 22 with a core forming curing resin and to form discharge portions 22b (refer to FIG. 2) for discharging the aforementioned resin from the concave portions 22 corresponding to the aforementioned convex portions 12, thereby fabricating a mold (refer to FIG. 1C).

To the mold 20 as fabricated supra is attached a cladding base material (a lower cladding layer) that has a surface area larger than a mold, on which cladding base material, for example, a conductive layer pattern 31 comprising an electronic circuit is formed (refer to FIGS. 1D and 2). FIG. 1D is a cross section view of the mold attached to the cladding base material, viewed at a right angle to the longitudinal direction of the concave portions (cross section along the line A-A in FIG. 2). Next, a few drops of a core forming curing resin 40a are dropped into the entry portions 22a of the mold 20 to fill the concave portions 22 of the mold with the resin via capillary action. At this time, the core forming curing resin is discharged from the discharge portions 22b located at the opposite ends of the concave portions 22 (not shown). FIG. 1E is a cross section view of the concave portions of the mold filled with the curing resin, viewed at a right angle to the longitudinal direction of the concave portions.

Then, the core forming curing resin within the mold concave portions is hardened and the mold is released. FIG. 1F is a cross section view of optical waveguide core portions 40 formed on top of the cladding base material, viewed at a right angle to the longitudinal direction of the core.

Moreover, on the surface of the cladding base material whereon the core portions are formed, an upper cladding layer 50 is formed, whereby a waveguide base material 60 of the invention having a polymer optical waveguide is completed. FIG. 1G is a cross section view of the polymer optical waveguide 60, viewed at a right angle to the longitudinal direction of the core.

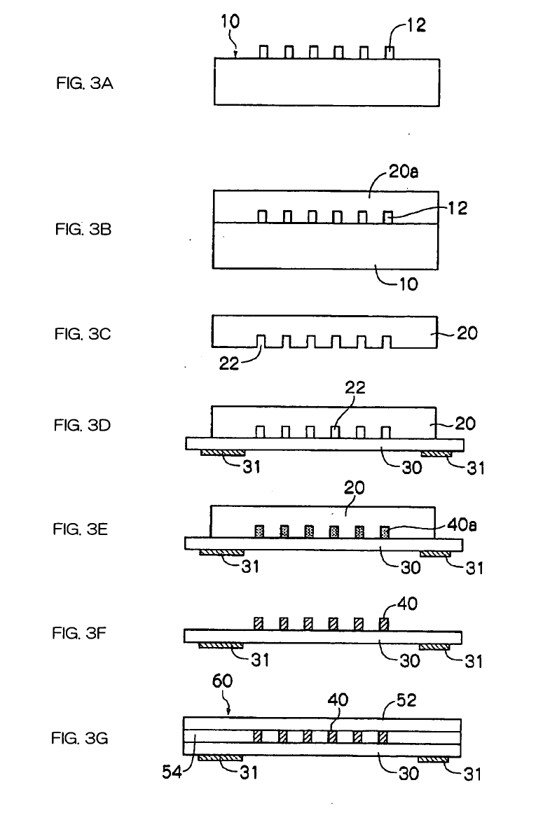

FIG. 3 shows an example that involves bonding a film to be an upper cladding layer to the surface of the film base material (cladding base material) on which the core portions are formed, by means of an adhesive. The processes in FIGS. 3A to 3F are common to those in FIGS. 1A to 1F, which indicate the process of preparation of a matrix to the formation of the core portions. FIG. 3G is a cross section view of the polymer optical waveguide sheet 60 obtained by a process of bonding the upper cladding layer (cladding film) to the surface of the film base material whereon the core portions are formed, by mean of an adhesive layer, viewed at a right angle to the longitudinal direction of the core.

Each example described above provides the upper cladding layer after forming the core portions by use of the mold, followed by the release of the mold. The invention, however, can directly use the mold as the upper cladding layer without releasing the aforementioned mold, as described infra, although this depends on the material of the mold.

A method for producing a polymer optical waveguide device of the invention will be set forth below in order of process.

Process of Preparing a Mold

The fabrication of the mold preferably uses a matrix on which are formed convex portions corresponding to core portions of an optical waveguide as described above, but is not limited thereto. A method of using a matrix will be described below.

For the fabrication of a matrix on which convex portions corresponding to core portions of optical waveguides are formed, the conventional methods that may be used without particular limitation include, for example, photolithography and the RIE method. The method of fabricating a polymer optical waveguide by the electrodeposition method or photoelectrodeposition method previously proposed by the present inventors (JP-A No. 2002-333538) can also be applied to the production of the matrix. The size of the convex portions corresponding to the core portions formed on the matrix (the length of a side of the cross section face in FIG. 1) is generally from about 5 to about 500 μm, preferably from about 40 to about 200 μm, and is determined depending on the applications or the like of the polymer optical waveguide. For instance, for an optical waveguide for a single mode, the size of the core that may be used is generally about 10 square μm; for an optical waveguide for a multi mode, the size of the core that may be used is generally from about 40 to about 150 square μm, and an optical waveguide having still a larger core portion of several hundred μm is also utilized depending on application.

The fabrication of a cured resin layer to be a mold includes applying a mold forming curing resin to or casting the curing resin on the surface on which convex portions corresponding to the core portions of a matrix produced as described supra, or as necessary dry treating and hardening the resin, and subsequently releasing the cured resin layer. In this cured resin layer entry portions are formed for filling the aforementioned concave portions with the core forming curing resin and discharge portions for discharging the aforementioned curing resin from the aforementioned concave portions, and the forming method thereof is not particularly limited. Convex portions corresponding to entry portions and discharge portions can be provided on the matrix in advance, and examples of a simple and easy method include a method that involves forming a cured resin layer of a mold forming curing resin on the matrix, releasing the resin layer to make a mold, and then cutting off both ends of the mold such that the aforementioned concave portions are exposed to form entry portions and discharge portions.

It is effective to provide penetrated pores communicated with the mold concave portions at the both ends of the concave portions. The penetrated pores of the entry port side can be utilized as liquid (resin) reservoirs; the penetrated pores of the discharge port side can have pressure reducing aspirating tubes inserted thereinto to connect the concave insides to a pressure reducing aspirating apparatus. In addition, the entry side penetrated pores can be connected to the injecting tubes of the core forming curing resin to pressure inject the resin. The penetrated pores may be provided, corresponding to each of the concave portions, depending on the pitches of the concave portions. One penetrated pore commonly communicated with each of the concave portions may also be provided.

Release procedure such as release agent application is also carried out on the aforementioned matrix to promote the release between the matrix and the mold in some cases.

As the aforementioned mold forming curing resin, it is preferable that the resulting cured material is able to be readily released from the matrix, that the cured resin has a certain value or more of mechanical strength and dimension stability as a mold (repeatedly used), and that the cured resin has good adhesion to a cladding base material. A variety of additives can be added to the mold forming curing resin as required.

The uncured state of a mold forming curing resin makes it possible to apply the curing resin to or cast it on the surface of a matrix. The convex portions corresponding to the individual optical waveguide core portions patterned on the matrix must also precisely be copied, so the viscosity of the uncured resin is preferably in the range of, for example, about 500 to about 7000 mPa.s. (In addition, the “mold forming curing resins” used in the invention also include elastic rubber-like bodies after curing.) A solvent may also be added for the adjustment of the viscosity to the extent that the solvent does not affect other members.

The aforementioned mold forming curing resins preferably use silicone rubber (silicone elastomers) or curing organopolysiloxanes as silicone resins, from the viewpoints of releasability, mechanical strength and dimensional stability, hardness, and adhesion to a cladding base material. The above-described curing organopolysiloxanes preferably include in the molecule at least one group selected from the group consisting of a methylsiloxane group, an ethylsiloxane group and a phenylsiloxane group. Additionally, the above-described curing organopolysiloxane may be a one-part type, or a two-part type, which is used with a curing agent in combination, a thermosetting type or a room-temperature curing type (e.g., a type cured by moisture in air), or further another type that makes use of curing (ultraviolet curing, etc.).

The above-described organopolysiloxane is preferably a species that becomes a rubber state after curing. This normally uses the so-called liquid silicone rubber (the “liquid-like” type also includes a high-viscosity type like a paste-like type). A two-part type is preferable that is used in combination with a curing agent. Of these, room temperature vulcanizing liquid silicone rubber is preferably used in that its surface and inside are uniformly cured in a short time, that the rubber produces no by-products during curing, and that the rubber exhibits excellent releasability and a small degree of shrinkage.

Of the aforementioned liquid silicone rubber, liquid dimethylsiloxane rubber is particularly preferable from the standpoints of adhesion, releasability, and the controllability of strength and hardness. The refractive index of a cured article of liquid dimethylsiloxane rubber is generally low, at about 1.43, so a cured resin layer as a mold fabricated from the rubber is not released from the cladding base material, and can directly be utilized as the upper cladding layer. In this case, a good way and mean is required in such a way that the cured resin layer, the filled core forming resin and the cladding base material are not released from each other.

The viscosity of the above-described liquid silicone rubber is preferably in the range of about 500 to about 7000 mPa.s, more preferably in the range of about 2000 to about 5000 mPa.s from the viewpoints of precisely copying the convex portions corresponding to the core portions of optical waveguides, decreasing the mixture of bubbles to readily deaerate and molding a mold having a thickness of a few millimeters. If the viscosity is less than 500 mPa.s, the injection efficiency is too good, whereby the liquid silicone rubber enters the interface between the cladding base material and the cured resin layer, leading to the deterioration of shape precision in some cases. If the viscosity exceeds 7000 mP.s, the injection speed does not increase, which poses a problem in impression precision, sometimes decreasing productivity, even though injection aid means is carried out.

The hardness of a cured resin layer to be a mold is preferably in the range of about 10 to about 50 in terms of shore A hardness. The use of a cured resin layer having such soft rubber-like properties can improve molding properties of the release subsequent to core portion molding, thereby being capable of imparting a precise core forming ability to the resin layer. The thickness of a cured resin layer can be selected with high precision from appropriate values that can maintain the molding precision to vibration and pressure changes during the injection of the core forming curing resin.

The hardness of the above-described cured resin layer is preferably in the range of about 15 to about 30 in terms of shore A hardness, from the viewpoints of impression performance, maintenance of a concave portion shape and releasability. If the shore A hardness is less than about 10, the form precision is decreased, which presents a problem in reproducibility of the shape; if the shore A hardness exceeds about 50, the surface of a molded article may be damaged because appropriate elasticity cannot be created in the form release from the mold.

The hardness of the above-described cured resin layer (shore A hardness) can be determined by means of a durometer in accordance with hardness testing methods for rubber, vulcanized or thermoplastic.

The surface energy of a cured resin layer to be a mold is preferably in the range of about 7 to about 30 mN/m, more preferably in the range of about 12 to about 21 mN/m. The presence of the surface energy in the range supra is preferable from the standpoints of adhesion to the cladding base material and the permeation speed of the core forming curing resin. If the surface energy is less than about 7 mN/m, permeation speed to the fine port (entry portion) of a core forming curing resin is decreased, which sometimes poses a problem in productivity. If the surface energy exceeds about 30 mN/m, the surface of the cured molded article is damaged due to the adherence of the surface in the mold release, leading to a great decrease in surface smoothness in some cases.

In the invention, the aforementioned surface energy is determined by the method that calculates the critical surface tension by the Zisman method.

The aforementioned critical surface tension can specifically be evaluated in the following. First, several species of n-alkane liquids, the surface tensions of which are known, are prepared (the alkanes have surface tensions in the range of about 20 to about 40 mN/m; (a) a liquid having the van der Waals force alone, (b) a liquid having a polar component, and (c) a liquid having a hydrogen bonding component are selected depending on the solid to be measured). Liquid drops of these are dropped onto the surface of the solid (the surface of a cured resin layer) with a syringe at about 20° C. and the contact angle θ relative to the solid surface of each of the liquid drops is determined by a contact angle meter (e.g., auto contact angle meter, trade name: CA-Z, manufactured by Kyowa Interface Science Co., Ltd.).

Next, the cos θ value of the aforementioned contact angle θ is plotted against each of the aforementioned liquids (Zisman plotting). The surface tension value of the point of intersection of the extrapolated line of the plotting and the line of cos θ=1.0 is defined as the critical surface tension (surface energy).

The arithmetic mean roughness Ra of the surface of the concave portion of a cured resin layer to be a mold is preferably in the range of about 10 nm to 0.1 μm, more preferably in the range of about 20 nm to about 0.05 μm. By rendering the surface roughness of the concave portion in the above-described range, light loss in optical waveguide properties of the core portion formed can be greatly reduced. More specifically, if the surface roughness of the core portion formed by the mold is about one-fifth or less the wavelength of light used, the leak of the light can sufficiently be restrained; if the surface roughness is about one-tenth or less, the wave guide loss due to the core surface roughness of the light is a level that can almost be neglected.

The above-described arithmetic mean roughness in the invention can be calculated by a well-known method using a comparative surface roughness standard strip.

The thickness of the cured resin layer to be the above-described mold is as necessary determined in consideration of handling properties as a mold, but is preferably in the range of about 5 μm to about 5 mm, more preferably in the range of about 30 μm to about 700 μm. Rendering the thickness, the hardness (elasticity) and the surface energy of the cured resin layer to preferable ranges as noted supra can cause appropriate the deformation and releasability of the cured resin layer during release, thereby being capable of restraining the interface detachment from the core portions after curing to maintain the surface smoothness of the core portions. More specifically, rendering the thickness, hardness and surface energy of the cured resin layer to the above-described ranges can attain an arithmetic mean roughness Ra of about 100 nm or less as the smoothness of the core portion surface, an Ra of about 40 nm or less if they are made more appropriate.

As described supra, the hardness (rubber elasticity), thickness and surface energy of a cured resin layer to be a mold are correlated to each other, and are important control properties depending on molding precision required. Satisfying these requirements achieves a manufacturing process that is capable of simply and partially forming an optical waveguide even on a base material on which electronic devices and electronic circuits are adjacently present. The fabrication of a high-density polymer optical waveguide with a low loss of light in such a manner is effective in that a fusion base material of an optical circuit and an electronic circuit can be obtained by means of a simple operation method and a few number of processes, even in the production of a polymer optical waveguide device into which optical devices are inserted as described infra.

The cured resin layer to be the mold preferably has an optical transparency of about 50%/mm or more in the ultraviolet region and/or in the visible region, and more preferably has an optical transparency of about 80%/mm or more. In particular, for a wavelength of light of about 365 nm, the cured resin layer preferably has an optical transparency of about 50%/mm or more. The reason why the optical transparency in the visible region is preferably about 50%/mm or more is that the position can readily be determined in a process of attaching a mold to a cladding base material as described infra, and that, in the subsequent process of filling a core forming curing resin, a state in which the concave portions are filled with the core forming curing resin can be observed, whereby the completion of filling can readily be confirmed. In addition, the reason why the optical transparency in the ultraviolet region is preferably about 50%/mm or more is that the ultraviolet-ray curing can efficiently carried out through a cured resin layer in the case where the ultraviolet curing resin is used as the core forming curing resin.

Of the above-described curing organopolysiloxanes, particularly, liquid silicone rubber to be silicone rubber after curing exhibits excellent properties of adhesion to and releasability from the cladding material, which are not conformable to each other, has the ability to copy the nano-structure, and can prevent even the penetration of a liquid when the silicone rubber is attached to a cladding base material. A cured resin layer as a mold using such silicone rubber copies a matrix with high precision and is attached to a cladding base material, thereby making it possible to efficiently fill only the concave portion between the mold and the cladding base material with a core forming resin, and in addition release of the cladding base material from the mold is easy. This mold extremely simply and easily enables the fabrication of a polymer optical waveguide that maintains the shape with high precision.

When a cured resin layer of the above-described cured resin layers, in particular, has rubber elasticity, the portion of the cured resin layer, i.e., the portion excluding the portion that copies the convex portions of the matrix, can be replaced by another rigid material. In this case, the handling properties of the mold and the response properties for mechanical and partial stress to the stretching change of the mold in the injection of a core forming resin are improved.

Process for Attaching the Mold to the Cladding Base Material

The cladding base materials used in the invention are a silicon base material, an electronic circuit base material and other base materials. The base material comprising the cladding base material is not particularly limited, and examples thereof include a silicone wafer, a glass base material, a ceramic base material, and a plastic base material.

When the refractive index of a base material is appropriate, it is directly used as a cladding base material; a base material the refractive index of which is required to be controlled is coated by resin coating or with an inorganic material by means of physical vapor deposition (PVD) on the entire surface of the aforementioned cladding base material or portion thereof as a cladding layer, and used. In the invention, a base material provided with the aforementioned cladding layer is also called a cladding base material.

The refractive index of a cladding base material (a cladding layer in the case where the aforementioned cladding layer is provided) in the invention is preferably less than about 1.55, more preferably less than about 1.49. In particular, the refractive index of the cladding base material needs to be 0.01 or more smaller than the refractive index of the core portion. This attributes to the refractive index of the core material of a trunk optical fiber being larger than about 1.47.

Additionally, the refractive index of each of the above-described base materials or layers is determined by means of an ellipsoidal refractometer (the refractive indexes of other core portions are determined similarly).

When the properties of a cladding base material include an arithmetic mean roughness Ra of about 0.1 μm or less for the smoothness of the surface, and exhibits excellent adhesion to the mold (cured resin layer), a cladding base material is preferable that does not create a cavity except the concave portions of the mold when the cladding base material is attached to the mold. When the cladding base material has not so good adhesion to the mold and/or the core portions, treatment in an atmosphere of ozone, or ultraviolet radiation treatment that excludes a wavelength of about 300 nm or less is preferably carried out on the base material to improve the adhesion to the mold.

A polymer optical waveguide using a flexible film of the above-described plastic base material as the cladding base materials is also usable as a coupler, optical wire between boards, an optical demultiplexer, or the like. The aforementioned film base material is selected depending on applications of a polymer optical waveguide to be fabricated, in consideration of its refractive index, optical properties such as optical permeability, mechanical strength, surface smoothness, heat resistance, adhesion to a mold, flexibility, etc.

Examples of the film base material include acrylic resins (polymethylmethacrylate), alicyclic acrylic resins, styrene-based resins (polystyrene, acrylonitrile/styrene copolymers), olefin-based resins (polyethylene, polypropylene, ethylene/propylene copolymers), alicyclic olefin resins, vinyl chloride-bade resins, vinylidene chloride-based resins, vinyl alcohol-based resins, vinyl butyral-based resins, allylate-based resins, fluorine-containing resins, polyester-based resins (polyethylene terephthalate, polyethylene naphthalate), polycarbonate-based resins, cellulose di-or triacetate, amidebade resins (aliphatic and aromatic polyamides), imide-based resins, sulfone-based resins, polyether sulfone-based resins, polyether ether ketone-based resins, polyphenylene sulfide-based resins, polyoxymethylene-based resins, silicone resins, blended materials of these resins.

Examples of the aforementioned alicyclic acrylic resins include OZ-1000 and OZ-1100 (both trade names, manufactured by Hitachi Chemical Co., Ltd.), which are produced by incorporation of aliphatic cyclic hydrocarbons such as tricyclodecane into ester substituents.

Examples of the aforementioned alicyclic olefin resins further include substances having a norbornene structure on the main chain, and substances having both a norbornene structure on the main chain and, on a side chain, a polar group such as an alkyloxycarbonyl group (examples of the alkyl group include an alkyl group having 1 to 6 carbon atoms and a cycloalkyl group). Of these, as described supra, an alicyclic olefin resin both having a norbornene structure on the main chain and a polar group on a side chain has excellent optical properties such as a low refractive index (the refractive index is approximately 1.50, thereby being capable of ensuring the difference of refractive index between the core gladdings) and a high optical permeability, excellent adhesion to the mold, and excellent heat resistance also, thereby being particularly suitable for the fabrication of a polymer optical waveguide.

The refractive index of the above-described film base material requires cladding function in some cases, so the refractive index is preferably less than about 1.55, more preferably less than about 1.51, upon ensuring the refractive index difference between the film and the core.

The thickness of the above-described film base material is appropriately selected in consideration of flexibility, rigidity and ease of handling, and is generally preferably in the range of about 0.03 mm to 0.5 mm.

The value of smoothness of the surface of a film base material to be used is preferably about 10 μm or less, more preferably about 1 μm or less, still more preferably about 0.1 μm or less, in terms of the arithmetic mean roughness Ra. When the value of smoothness of the surface of a film base material exceeds about 10 μm in terms of Ra, the shape forming precision of a core portion to be formed is decreased, thereby making it difficult to use on account of an increase in propagation loss of light in some cases. Even for the provision of an undercoat layer, the value of smoothness of the surface of a film base material exceeds 10 μm, which frequently poses large problems in coating properties and smoothness of the undercoat layer. In other words, even for the use of a film base material, which is finally the cladding base material, the value of the arithmetic mean roughness Ra of the surface is to be preferably about 0.1 μm or less, as described supra.

The aforementioned electronic circuit base material is fabricated by totally or partially forming conductive layers on the unformed portions of the cored portions of a cladding base material by means of the method of application, the PVD method, the adhesion method for foil, etc, and then patterning the resulting material using a common method (photolithography, dry etching, the laser heating scanning method, the electron discharging method, etc.). Examples of the aforementioned conductive layer include one layer or a composite thin layer containing a metal such as chromium, copper, aluminum, gold, molybdenum, nickel, silver, platinum, iron, titanium, zinc, tungsten, or tin, or an alloy containing a metal thereof, a layer of a conductive metal compound, a thin film produced by addition of a conductive fine powder such as carbon black to a polymer material.

In particular, the conductive pattern of the electronic circuit is particularly preferably formed using gold, copper, aluminum, molybdenum, nickel or an alloy thereof, which is conformed to the wire bonding method or flip chip packaging, in order to be capable of packaging of electrical conduction among the electronic devices and optical control devices.

The thickness of the aforementioned conductive layer is suitably in the range of about 0.05 to 30 μm, more preferably in the range of about 0.2 to 2 μm. Additionally, the conductive layer for the electronic circuit is preferably provided on the unformed portions of the cored portions of a cladding base material, and is capable of being stacked. Process of filling the concave portions of a mold to which a cladding base material is attached with a core forming curing resin

Filling of the concave portions of the mold with a core forming curing resin may involve attaching to the mold a cladding base material that is one size larger than the mold, and injecting a small amount of core forming curing resin into the entry portions of the concave portions to fill by capillary action, or pressure filling the entry portions of the concave portions with the core forming curing resin, or injecting a small amount of core forming curing resin into the entry portions of the concave portions and then pressure-reduction aspirating the discharge portions of the concave portions, or injecting a small amount of core forming curing resin into the entry portions of the concave portions and then performing both the pressure filling and pressure reducing aspiration. When penetrated pores are provided in the concave portion ends as discussed supra, the resin can be kept in the entry side penetrated pores and be pressure filled, or pressure reducing aspirating tubes can be inserted into the discharge side penetrated pores and pressure reducing aspiration can be carried out.

Performing the aforementioned pressure filling and pressure reducing aspiration at the same time when they are used in combination, and further increasing the pressure in the aforementioned pressure filling gradually and decreasing the pressure in the aforementioned pressure reducing aspiration gradually are preferable from the viewpoint of enabling the the incompatibility of the core forming curing resin being injected still more rapidly in a state in which the mold is stably fixed to be overcome.

The pressure reduction in the aforementioned pressure reducing aspiration is preferably in the range of about −0.1 to about −100 kPa, more preferably in the range of about −1 to about −50 kPa, relative to normal pressure.

Resins showing radiation hardenability, electron ray hardenability, thermosetting properties, and other properties can be used as the core forming curing resins. Of these, an ultraviolet ray curing resin and thermosetting resins are preferably used. As the ultraviolet curing resins or thermosetting resins for the above-described curing, monomers or oligomers exhibiting ultraviolet hardenability, or thermosetting properties, or mixtures of monomers and oligomers thereof can preferably be utilized. In particular, a mixture of the oligomers serves to aid in speeding up the hardening and to improve the precision of the shape.

The above-described ultraviolet ray curing resins that are preferably used include ultraviolet ray curing resins comprising epoxy compounds, polyimide compounds, and/or acryl compounds.

The core forming curing resin needs to be low in viscosity sufficient enough to be capable of being filled in the voids (the concave portions of the mold) produced between the mold and the cladding base material. The viscosity when the aforementioned core forming curing resin is uncured is preferably in the range of about 50 mPa.s to about 2000 mPa.s, more preferably in the range of about 100 mPa.s to about 1000 mPa.s, still more preferably in the range of about 300 mPa.s to about 700 mPa.s, which desirably makes the speed of filling high, the core shape good, and the light loss light. When the viscosity of the core forming curing resin is less than about 50 mPa.s, the core forming curing resin enters voids that require none of the resin, between the mold and the cladding base material, sometimes creating the variation of the moldability and shape, losing properties of the core forming curing resin; when the viscosity exceeds about 2000 mPa.s, the penetration speed dramatically becomes slow, thereby lowering the productivity in some cases.

In addition to those noted supra, for the reproduction of the original shape, with high precision, of the concave portions corresponding to the core portions of the light waveguides patterned in the matrix, the volume change prior to and subsequent to curing of the above-described curing resin needs to be small. For instance, a decrease in volume causes a large loss of the waveguide. As such, the above-described curing resin preferably has a volume change as small as possible. The volume change is preferably about 10% or less, more preferably in the range of about 0.01 to about 4%. Making the viscosity lower with a solvent is preferably avoided if possible because the volume change before and after curing is large. However, a material having a volume change of about less than 0.01% or a material exhibiting volume expansion renders the efficiency of the release from the mold lower and produces surface deterioration such as the break of the core portion surfaces in the release from the mold, so the smoothness of the surface is decreased and the loss of optical wave guiding is increased, thereby being not preferable.

For a small volume change (shrinkage) after curing of the core forming curing resin, a polymer can be added to the above-described resin. Preferably, the aforementioned polymer is compatible with the core forming curing resin and does not have adverse effects on the refractive index, elastic modulus, and permeability of the curing resin. The addition of a polymer also decreases the volume change as well as being capable of highly control the viscosity and the glass transition point of the cured resin. Examples of the above-described polymer include (but are not limited to) acrylic polymers, methacrylic polymers, and epoxy polymers.

The refractive index of the cured material of a core forming curing resin is preferably in the range of about 1.20 to about 1.60, more preferably in the range of about 1.4 to about 1.6; two or more kinds of resins having different refractive indexes when cured are sometimes used that are within the aforementioned ranges.

The refractive index of the cured material of a core forming curing resin needs to be larger than that of a cladding base material (a cladding layer in the case of having the above-described cladding layer). The difference of refractive index between the core portion and cladding base material is preferably about 0.01 or more, more preferably about 0.05 or more.

In this process, for the promotion of filling the concave portions of the mold with a core forming curing resin via capillary action, the entire system is desirably reduced (the range of about −0.1 to −200 Pa relative to normal pressure).

Also, for further promotion of the aforementioned filling, in addition to the pressure reduction of the above-described system, making the viscosity low by heating a core forming curing resin filled from the entry portions of the mold is also an effective means. Furthermore, upon injection, a mean of attaining a pressure level smaller than the actual level of pressure reduction is effective as well.

Process for Hardening a Core Forming Curing Resin Filled

In this process, a core forming curing resin filled is hardened by a variety of means. Hardening of an ultraviolet curing resin makes use of an ultraviolet ray lamp, an ultraviolet ray LED, a UV radiation apparatus, etc. In addition, for hardening of a thermosetting resin, a mean is effective that accelerates the hardening by heating in an over, or the like.

Other Processes

In the invention, prior to the insertion of optical devices as described infra, etc., the following processes can be provided as necessary.

Process of Releasing the Mold From the Cladding Base Material

This process is a process of releasing the mold from the cladding base material after the process of hardening the core forming curing resin. As discussed supra, a cured resin layer used as the mold in the above-described each process can also directly be used as the upper cladding layer if conditions such as the refractive index are satisfied. In this case, the mold is preferably subjected to ozone treatment for the improvement of adhesion of the mold and the core portions.

Process of Forming an Upper Cladding Layer on the Cladding Base Material Formed on the Core Portions

This process forms the upper cladding layer on the cladding base material on which the core portions are patterned; the upper cladding layers include, for example, a film (e.g., a base material for the above-described cladding material is similarly used), a layer cured after application of a cladding curing resin, and a polymer film obtained by drying after application of a solution of a polymer material. The aforementioned cladding curing resin preferably utilizes an ultraviolet curing resin and a thermosetting resin; examples thereof include ultraviolet ray curing and thermosetting monomers and oligomers and mixtures of the monomers and the oligomers.

To make the volume change (shrinkage) small after curing of the above-described cladding forming curing resin, to the resin can be added a polymer that is conformed to the curing resin and does not have adverse effects on the refractive index of the resin, elastic modulus, and permeability (e.g., a methacrylic polymer, an epoxy polymer).

When a film is used as the upper cladding layer, an adhesive is used to bond them together. At this time, the refractive index of the adhesive is desirably close to the refractive index of the film. As an adhesive to be used, an ultraviolet ray curing resin or a thermosetting resin is preferably used; examples thereof include ultraviolet ray curing and thermosetting monomers and oligomers and mixtures of the monomers and the oligomers. In addition, to make the volume change (shrinkage) small after curing of the aforementioned ultraviolet ray curing resin or thermosetting curing resin, a polymer similar to a polymer added to the upper cladding layer can be added thereto.

The refractive index difference between the aforementioned cladding base material and upper cladding layer would preferably rather be small; the difference is preferably about 0.1 or less, more preferably about 0.05 or less, still more preferably about 0.001 or less; no difference is most preferable from the standpoint of optical confinement.

In the production of a polymer optical waveguide as described supra, in particular, in the use of a combination of liquid silicone resins to be cured to a rubber-state as mold forming curing resins, and containing a liquid dimethylcyclohexane solution therein, and an alicyclic olefin resin, as a cladding base material, having both a norbornene structure on the main chain and, on a side chain, a polar group such as an alkyloxycarbonyl group, enables rapid filling of the curing resin in the concave portions because the adhesion of both is particularly high and its mold concave portion structure is not deformed, even though the cross-sectional area of the concave portion structure is extremely small (e.g., a rectangle measuring about 10×10 μm).

In the fabrication of a polymer optical waveguide of the invention, in the process of preparing the aforementioned mold, preferably, an entry port and a discharge port are provided in the above-described cured resin layer and the cured resin layer is reinforced with a reinforcing member. An injection port is provided in this reinforcing member for the pressure injection of a core forming curing resin thereinto. An injection tube is inserted into and connected to the injection port. A plurality of injection ports are provided and pressurized states are preferably uniform in the entry ports (filling ports) of the above-described respective concave portions. Furthermore, discharge ports are provided in the side opposite to the injection ports of the reinforcing members (the side of the core resin being discharged from the mold concave portion) such that the filling speed can further be increased by creating a reduced pressure state inside the mold; and pressure reducing degassing tubes are inserted into and connected to the discharge ports, whereby pressure reducing aspiration can be carried out from the aforementioned concave portion discharge ports. A plurality of discharge ports are provided and preferably reduced pressure states in the discharge ports of the mold concave portions do not deviate.

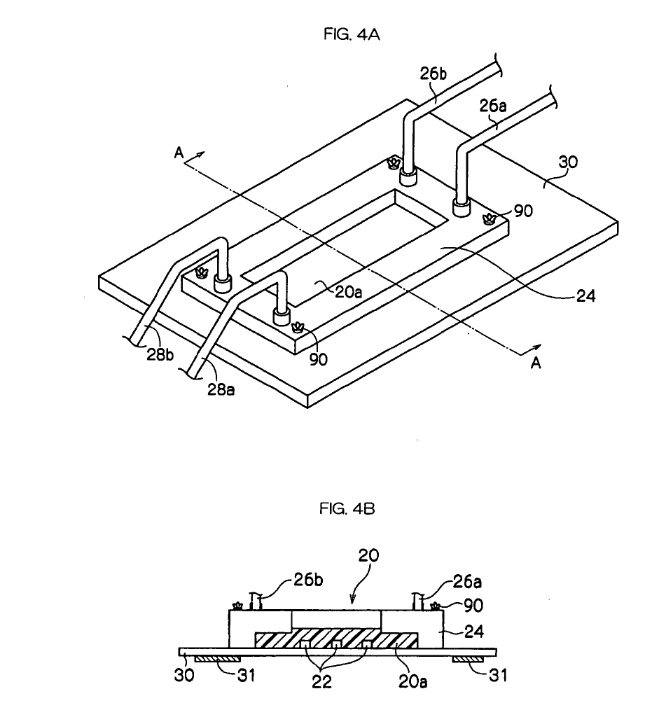

The use of the mold provided with the aforementioned reinforcing member will be described in accordance with drawings. FIG. 4A is a perspective view in which a mold having a reinforced member is attached to a cladding base material. Reference numeral 24 in FIG. 4A is a reinforcing member that is cut out in the mold concave portion forming region (region irradiated with ultraviolet rays, etc.). Reference numerals 26a, 26b are injection tubes, reference numerals 28a, 28b are pressure reducing degassing tubes, and reference numeral 90 is a screw for fixing the reinforcing member 24 and the cladding base material 30 in such a way that the respective positions thereof do not deviate even slightly. Reference numeral 20a is the cured resin layer of the mold and is not covered with the reinforcing member.

FIG. 4B is a cross section view taken along the line A-A in FIG. 4A and reference numeral 22 shows the mold concave portions.

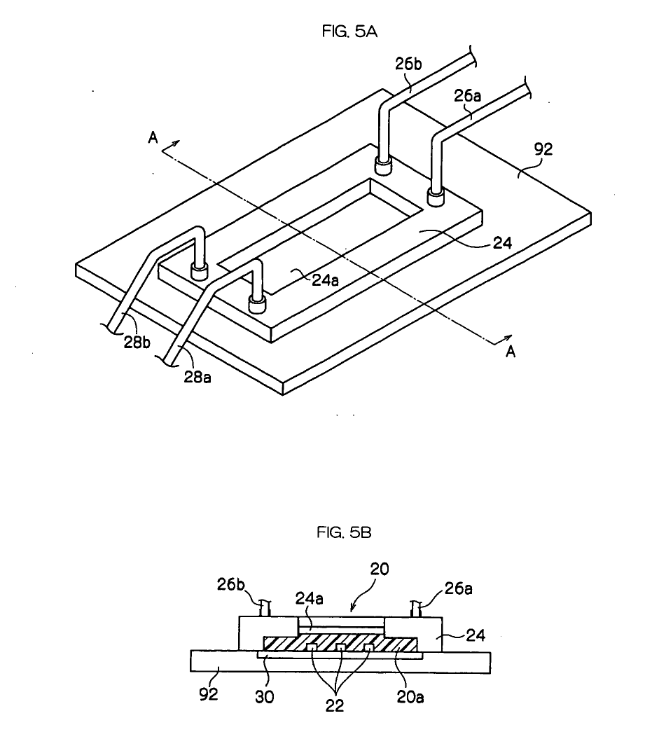

FIGS. 5A and 5B are illustrative of a mold equipped with a reinforcing member as in FIG. 4; the system uses a holding member 92 having a holding portion (concave portion) holding a cladding base material such that the positions of the cladding base material and the mold do not deviate. This is also particularly effective when a flexible film is employed as a cladding base material. This example involves using an optically transparent base material 24a like a quartz plate, a glass plate, or a rigid plastic plate in the mold concave portion forming region (radiation region for ultraviolet rays, etc), molding in advance a groove portion having a size slightly larger than that of the core portion in a shape similar to the aforementioned concave portion, and then fabricating the cured resin layer portion of the mold by use of the matrix of the core along the groove. This can solve the instability of the mold due to vibration and deformation attributable to the concave portion of the rigid body even for a rubber-like resin cured layer in which the elastic modulus properties, which are a defect of the resin cured layer, are suppressed by densification thereof, thereby enabling attainment of high precision molding performance.

In addition, the aspect of the mold having a reinforcing member is not limited to the example described supra.

The aforementioned reinforcing member is fabricated with a metal material, a ceramic material, a rigid plastic material, or a composite material thereof; the thickness of the member is suitably in the range of about 1 mm to about 40 mm.

In the fabrication of a polymer optical waveguide in the invention, if a core forming curing resin is pressure filled from the entry portion of the mold, or if besides this the discharge portions of the mold concave portions are pressure-reduction aspirated, to promote the filling speed as noted supra, there are possibilities that there is position deviation between the mold and the cladding base material if a pressure change, either increased pressure or decreased pressure, is caused, or that the mold is deformed if vibrations are created in the entire or partial mold, or that the adhesion of the mold to the cladding base material is lost. The provision of a reinforcing member, however, eliminates these problems, thereby enabling increase of the filling speed without loosing the precision of the core shape.

If a plurality of core portions of optical waveguides are formed on the cladding base material, a void portion for relieving pressure is preferably provided in the cured resin layer of the mold on which a reinforcing member is provided as described supra. The void portion refers to a common space communicated with all the entry ports (the injection ports of a core forming curing resin) in an end of the plurality of concave portions of the mold. Moreover, in addition to the aforementioned voids, a void portion is preferably provided that is communicated with all the discharge ports in the other ends of the plurality of concave portions of the mold. The provision of the void portion in the entry ports prevents the application of a direct injection pressure to the entry ports, thereby relieving and homogenizing the injection pressure with respect to each of the entry ports. The provision of the voids in the discharge ports relieves and homogenizes the negative pressure of aspiration, thereby uniformizing the injection of the resin into each of the concave portions of the mold.

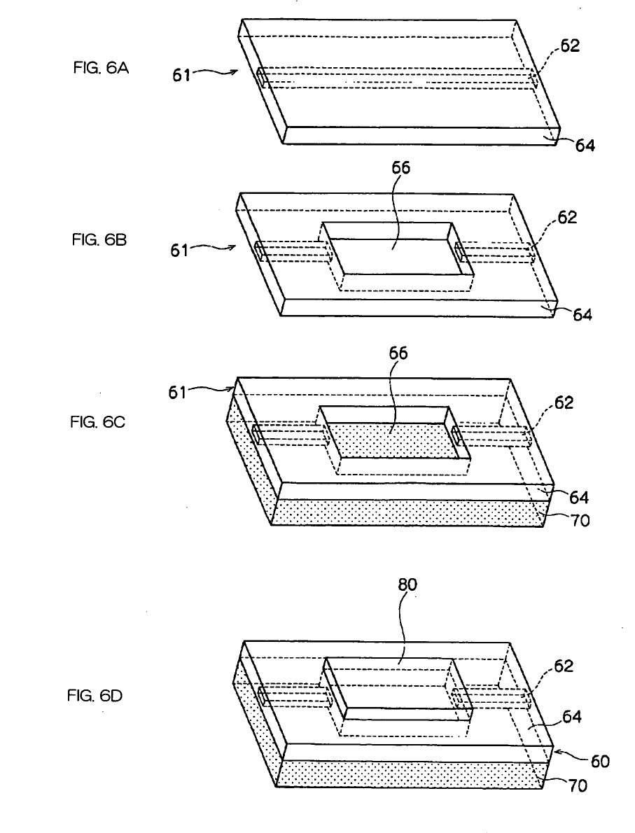

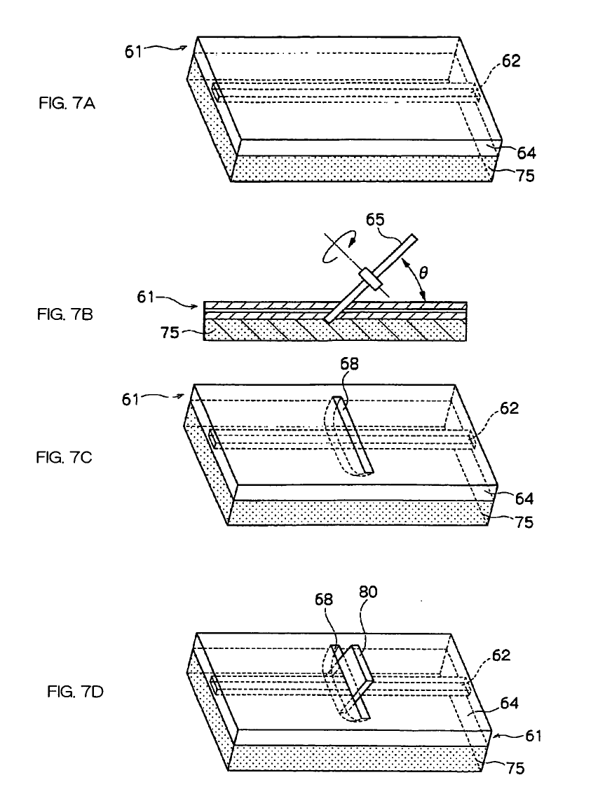

Next, each process of fabricating a polymer optical waveguide device into which an optical device is incorporated by means of a fabricated polymer optical waveguide will be set forth in accordance with FIGS. 6 and 7.

FIG. 6 is a schematic view indicating an example of providing an optical device with a polymer optical waveguide; in this example the bottom surface of a planar optical device (widest surface) is inserted towards a space fabricated by cutting a core portion 62. FIG. 6A is a perspective view indicating a waveguide base material fabricated (in a state in which the core portion 62 penetrates a cladding portion 64, hereinafter, the same), FIG. 6B is a perspective view indicating a state in which a space 66 is produced in the waveguide base material 61, FIG. 6C is a perspective view indicating a state in which the waveguide base material 61 in which the space 66 is fabricated is attached to a rigid base material 70, and FIG. 6D is a perspective view indicating a state in which an optical device 80 is placed in the space 66.

FIGS. 7A to 7D are schematic diagrams indicating another example of providing a polymer optical waveguide with an optical device; in this example the side surface of a planar optical device is inserted towards a groove fabricated by cutting a core portion 62. FIG. 7A is a perspective view indicating a waveguide base material disposed on a base material, FIG. 7B is a perspective view indicating a state in which a groove is being produced on a waveguide base material 61, FIG. 7C is a perspective view indicating a waveguide base material 60 in which a groove 68 is produced, and FIG. 7D is a perspective view indicating a state in which an optical device 80 is inserted in the groove 68.

FIGS. 6A to 6D and FIGS. 7A to 7D indicate examples in which one optical device 80 is inserted into one core portion 62, but in the invention a plurality of cores may be present with respect to one optical device. In addition, the shape of a core portion may be a linear shape, or a curved shape (the curvature radius being about 1 mm or greater).

Each process will be set forth in the following.

Process of Forming a Space or a Groove for Disposing an Optical Device

A polymer optical waveguide completed as discussed above includes a film as a cladding base material or a core portion as a waveguide on a rigid base material, and further an upper cladding layer on the cladding base material in such a way that the upper cladding layer covers the core portion. In this process, an optical device is inserted somewhere in the polymer optical waveguide, whereby a space or a groove is formed so as to cut the core portion in an intermediate portion in the waveguide direction of the core portion.

The term “space” stands for, as indicated in FIG. 6D for example, a blanked portion produced in a wide area so as to cut the core portion 62 from a side of the waveguide base material 61 in order to be able to insert and horizontally place the planar optical device 80 in an intermediate site of the core portion 62. The term “groove” means, as indicated in FIG. 7D for example, a cut portion produced in a narrow area so as to cut the core portion 62 from a side of the waveguide base material 61 in order to be able to insert the plate-like optical device 80 in an intermediate site of the core portion 62. The groove 68 may reach the edge of a direction that intersects the waveguide direction of the waveguide base material 60, in contrast to the above-described space 66.

Both the above-described space and groove may be formed so as to cut the core portion 62 and is not necessarily fabricated so as to penetrate the waveguide base material 61. However, as will be discussed infra, particularly when the space 66 is formed and the plate-like optical device 80 or the like is inserted thereinto, the space and groove are preferably formed so as to penetrate the waveguide base material from the viewpoint of ensuring the precision of positioning between the core portion 62 and the optical device 80.

For the formation of the intermediate space of the core portion 62 and the groove cutting the core portion 62, cutting methods (methods using, for example, die cutting, the Thompson blade, and the force-cutting blade), cut-off methods (methods via laser beam scanning, precision needle scanning, etc), and machining methods (methods by means of dry etching, wet etching, machining, etc) can be utilized. Of these, particularly, the method of producing a cut groove using a dicing machine for wafer cutting is preferable from the standpoint of obtaining the optical surface precision of an end waveguide surface (the surface roughness Ra is about 100 nm or less).

In the invention, the above-described space 66 and groove 68 are preferably formed to be slightly larger than the optical device 80. This is because optical loss is large for the insertion of the optical device 80 as described infra when an air layer is present between the cut end of the core portion 62 and the optical pathway portion of the optical device, so the filling of an optical adhesive in voids therebetween is preferable.

More specifically, the space 66 or the groove 68 is preferably formed that has a length in the wave guide direction of about 3 μm to about 5 mm longer than the length, in the waveguide direction, of a disposed optical device 80, and the space 66 or the groove 68 is more preferably formed that has a length in the wave guide direction of about 20 μm to about 1 mm longer. When the difference of the aforementioned length is less than about 3 μm, the insertion of the optical device 80 is difficult and also the filling of an optical adhesive is difficult in some cases. When the difference of the aforementioned length exceeds about 5 mm, the optical loss sometimes becomes large even though an optical adhesive is filled.

In the process of forming the above-described space and groove in the invention, the space and groove are formed so as to penetrate through the cladding base material, as shown in FIG. 6B, and prior to insertion of an optical device, the rigid base material 70 is preferably attached, as an underlying material, to the surface opposite to the surface in which the core portion 62 of the cladding base material in the waveguide base material 61 is formed, as indicated in FIG. 6C. Disposing an optical device on an underlying material that is provided in this manner (FIG. 6D) enables high precision positioning of the core portion 62 with respect to the optical portion of the optical device in a height direction (the thickness direction of the waveguide base material).

The material of the aforementioned rigid base material 70 is not limited to glass, metal, ceramics; the arithmetic mean roughness Ra of the surface is preferably in the range of about 20 nm to about 2 μm, more preferably in the range of about 0.1 to about 0.5 μm. If the Ra exceeds about 2 μm, high precision of figuring can not be obtained in some cases even though an underlying material is provided. Additionally, if the Ra is less than about 20 nm, the surface material is actually costly and is difficult to obtain.

On the other hand, as illustrated in FIG. 7B, when a dicer blade 65 is used to produce a groove with a certain angle θ in the waveguide base material 61, when, in particular, the cladding base material constituting the waveguide base material 61 is film or the like, as shown in FIG. 7A, a supporter 75 may be provided to the waveguide base material 61 from the beginning, for the fixation and stabilization of the waveguide base material 61 itself.

Process of Inserting an Optical Device and Positioning

In this process, an optical device to be disposed is prepared and the optical device is inserted into the space or groove produced as described supra and positioned. In the invention, an end surface of a core portion cut during the production of the above-described space can directly be use for an optical end surface having little connection loss since the optical waveguide is a polymer. When the optical waveguide is an optical waveguide made of a normal stiff inorganic material, an optical device inserted is also stiff, so the insertion is difficult; when the optical waveguide is a polymer optical waveguide, the insertion can readily be carried out due to the waveguide having a slight elasticity.

In this case, when an optical device is inserted into a space or groove that has been formed, the optical device is preferably positioned such that the maximum void width between the optical pathway portion of the optical device and the end surface of the cut core portion is about 0.4 mm or less, and more preferably positioned such that the maximum void width is about 0.15 mm or less.

The aforementioned maximum void width stands for the length such that the distance between the aforementioned optical pathway portion and the end surface of the core portion when an optical device is placed in the space or the groove is longest. If the maximum void width exceeds about 0.4 mm, the optical loss is large in some cases even if an optical adhesive is filled in voids as described infra.

The deviation width between the core portion and the optical pathway portion of the optical device in a height direction is preferably about ±10% or smaller of the core diameter.

The optical devices used in the invention include active optical devices such as an optical switch, and passive optical devices such as an optical filter, an optical reflecting plate, a diffraction grating, and an optical lens; of these, the optical device that is used is preferably at least one selected from the group consisting of an optical filter, an optical lens, an optical mirror, an optical switch, a light emitting device and a light receiving device.

Use of a device mounting base material when the above-described optical device is inserted is preferable from the viewpoints of supporting the optical device inserted and improving the precision of positioning. Examples of the aforementioned device mounting base material include a quartz base material, a silicon wafer and a highly smooth film. Process of optically bonding the optical pathway portion of the optical device to the core portion

This process is a process of optically bonding the optical pathway portion of the inserted optical device to the core portion. The aforementioned optical bonding is possible in a state in which the optical device is left inserted, but the positioned optical device is preferably fixed by some method to prevent the deviation of positioning. Also, in a state in which the optical device is left inserted, the refractive index between the optical device and the core portion is large since the voids between the optical device and the core portion are an air layer, whereby the optical loss is large. Accordingly, in the invention, in a micro-space between the optical pathway portion of the optical device that is inserted and disposed and the core portion is preferably filled with an optical adhesive having a refractive index difference of about ±0.2 or less relative to the refractive index of the core portion, and more preferably filled with an optical adhesive having a refractive index difference of about ±0.05 or less.

In particular in the invention, the waveguide is an organic species composed of a polymer material, and an optical adhesive normally used is also an organic species, so compatibility when both are attached together can be good and the refractive index difference can be small, whereby the optical loss when optically bonded can be made small as compared with the case of an inorganic speciesbased waveguide. In addition, expansion and shrinkage properties due to heat are restricted when the waveguide and the adhesive are organic material, whereby the mechanical strength of the bonded portion can be increased.

The above-described refractive index difference is more preferably about ±0.1 or less, still more preferably about ±0.03 or less, most preferably about ±0.01 or less.

The refractive index difference of the aforementioned optical adhesive relative to the core portion is about ±0.1 or less, and the use of an optical adhesive having an optical transmittance in a use wavelength range of about 90%/mm or greater is most preferable for lessening the optical loss via bonding.

The above-described optical adhesive may be any of a photo-curing adhesive and thermosetting adhesive (including room-temperature curing), and is preferably an adhesive having organic solvent dispersion characteristics, organic solvent solubility characteristics, etc, which preferably makes the above-described filled portion be solidified by light radiation, heat treatment, drying, etc. after filling. In particular, the use of a photo-curing adhesive treated at near room temperature during curing is effective in terms of dimension precision for bonding. This adhesive enables optical connection, thereby being capable of reducing the loss of optical properties and obtaining stable optical performance. Also, the adhesive can cause mechanical strength after hardening to be exhibited.

Preferable examples of the above-described adhesive include ultraviolet ray curing resins and/or thermosetting resins composed of epoxy compounds, polyimide compounds and/or acrylic compounds, similar to the above-described core forming curing resins.

A polymer optical waveguide device in the invention is fabricated through the processes as discussed supra. Next, a preferable aspect of bonding an optical device to the waveguide according to the invention will be presented.

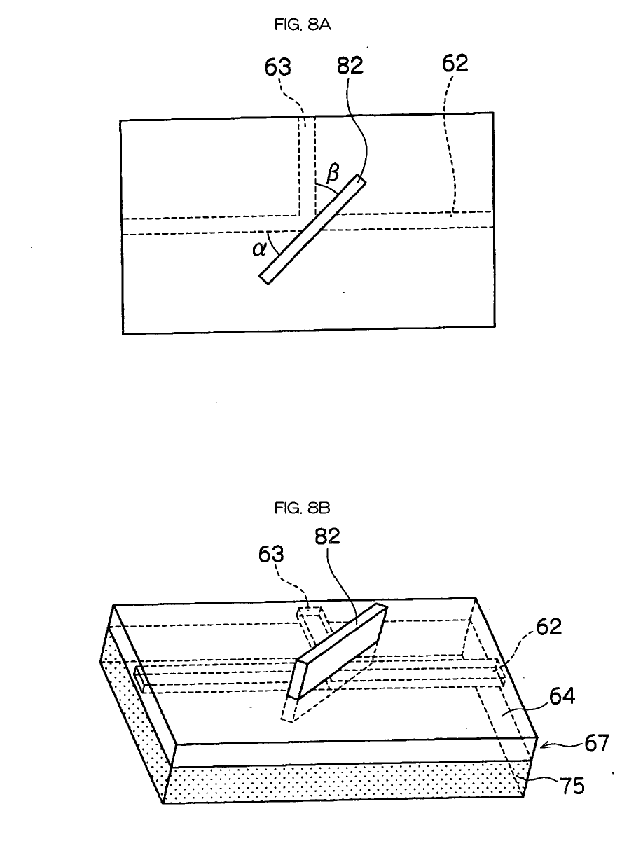

FIGS. 8A and 8B are diagrams indicating optical bonding by use of a wavelength selecting optical filter as an optical device, as an example of bonding an optical device to the waveguide according to the invention. FIG. 8B is a perspective view of a polymer optical waveguide device as fabricated; FIG. 8A is a diagram viewed from the upper cladding layer side of the polymer optical waveguide device.

A wavelength selecting optical filter 82 in the figures is a filter that transmits light of a constant wavelength and reflects light of a different, constant wavelength. The wavelength selecting optical filter 82 is inserted into a groove produced in the waveguide base material 67, and positioned at an angle of α (degrees) to light incident in the wave guide direction of the core portion 62. In the invention, it is preferable that the aforementioned angle α be within about 55 degrees±about 35 degrees (both inclusive), from the viewpoint of balance between the amount of reflection light towards the light reflecting core portion 63 and the amount of transmission light.

It is preferable that the angle β (degrees) of the aforementioned reflecting light core portion 63 relative to the wavelength selecting optical filter be within about ±10° (inclusive) of the aforementioned incidence angle a, similarly from the viewpoint of balance between the amount of reflection light towards the light reflecting core portion 63 and the amount of transmission light.

The method of producing polymer optical waveguide devices of the invention can inexpensively provide an optical device having simple functionality between wave guides (core portions) of the waveguide film or the waveguide base material without requiring complicated processes, and can inexpensively give, within one base material, optical modules and optical interconnection, optical circuit boards, media converters, and optical network units.

### EXAMPLES

The present invention will hereinafter be set forth in more detail in terms of Examples, but the invention is by no means limited to the Examples.

### Example 1

Production of a Mold

An ultraviolet ray curing thick film resist (trade name: SU-8, manufactured by Micro Chemical Inc.) is applied to the surface of a quartz base material by spin coating and the resulting material is pre-baked in a heating oven. Five convex portions (width: 50 μm, height: 50 μm, pitch: 250 μm, length: 50 mm) made of an ultraviolet ray cured polymer material having the cross-section of a square are patterned on the material by a photolithographic process to fabricate a matrix for the production of a mold.

Next, an opening portion through which ultraviolet rays are transmitted is provided as shown in FIG. 4A, and a reinforcing member (made of aluminum strip having a thickness of 1.5 mm) having three injection ports and three discharge ports is prepared, and then five concave portions (width: 100 μm, height: 100 μm, pitch: 500 μm, length: 50 mm) having a shape similar to the concave portions correspondent to the above-described convex portions are produced in a quartz transmission base material with a thickness of 2 mm by a photolithographic process and a hydrofluoric acid etching process to integrate it with the above-described reinforcing member. Then, the aforementioned matrix is covered with this reinforcing member.

Next, into the opening portion of the reinforced member is flowed a mixture of thermosetting liquid dimethylsiloxane rubber (trade name: SYLGARD® 184, dimethylpolysiloxane, manufactured by Dow Corning Asia Ltd., viscosity: 1000 mPa.s) and its curing agent, and the resultant material is heated and hardened at 130° C. for 20 minutes. After hardening, the cured rubber (the cured resin layer), the transmission base material and the reinforced member are removed integrally from the matrix, and a rubber mold is fabricated that possesses the concave portions correspondent to the above-described convex portions, and has entry portions for filling a core forming curing resin and discharge ports for discharging the resin from the concave portions formed therein.

Regarding the physical properties of the silicone rubber material (the cured resin layer) at this time, the hardness is 20 in terms of shore A hardness, the surface energy is 18 mN/m, the mean rubber thickness is 200 μm, and the arithmetic mean roughness Ra of the concave portion formed is 0.04 μm.

Formation of the Core Portions and an Upper Cladding Layer

The aforementioned rubber mold is attached to an unformed surface of a conductive layer pattern provided in advance with a heat resistant transparent resin film (trade name: ARTON® FILM, manufactured by JSR Corporation, thickness: 188 μm, refractive index: 1.51). To each of the injection ports and the discharge ports of the reinforced member of the above-described rubber mold are connected a pressure injection tube and a pressure reducing degassing tube. Thereafter, an ultraviolet ray curing resin having a viscosity of 1100 mPa.s (trade name: PJ 3001, manufactured by JSR Corporation) is injected at an application pressure of +20 kPa relative to normal pressure from the pressure injecting tube into the mold concave portions via a pressure adjusting controlling machine. Additionally, at the discharge ports of the mold, a pressure reducing aspiration of −50 kPa is carried out at a static pressure through a pressure reducing degassing tube. In this state the ultraviolet ray curing resin is filled into the mold concave portions over 40 seconds.

Next, the pressure injecting tube and pressure reducing degassing tube are removed from the above-described reinforcing member, and the core forming curing resin is irradiated with UV light having a light intensity of 50 mW/cm² for 10 minutes from the light exposing opening of the reinforcing member to harden the core forming curing resin. After the rubber mold is removed, core portions having a refractive index of 1.54 are patterned on the film.

An ultraviolet ray curing resin having, after curing, a refractive index of 1.51 which is the same as the refractive index of the film is applied to the entire surface for the core forming of the film, and the resulting material is irradiated with UV light having a light intensity of 50 mW/cm² for 10 minutes to harden the material and form an upper cladding layer having a layer thickness of 20 μm, obtaining a flexible polymer optical waveguide. The mean wave guide loss of this polymer optical waveguide is 0.12 dB/cm. Groove formation, insertion and positioning of an optical device, and optical bonding

Next, a groove having a mean width of 0.55 mm is formed to a length of 10 mm on the waveguide base material so as to cut the core portions, at an angle of 45 degrees relative to the waveguide base material surface, as shown in FIGS. 7B and 7C, by dicing by means of a dicer apparatus having a dicer blade of a thickness of 0.5 mm. Then, into this groove a wavelength selecting optical filter with a thickness of 0.5 mm that reflects light having a wavelength of 1.3 μm and transmits light having a wavelength of 0.85 μm is inserted, and the optical filter is positioned in such a way that the maximum void width between the cut core portion ends and the optical pathway portions of the wavelength selecting optical filter is 0.1 mm.

Subsequently, an ultraviolet curing optical adhesive with a refractive index of 1.531 that transmits light having wavelengths of 0.85 μm and 1.3 μm at 90%/mm (photo-curing adhesive, manufactured by Daikin Industries, Ltd.) is injected between the filter and the core portion ends, and the ultraviolet curing optical adhesive is irradiated with an ultraviolet ray of 360 nm to harden the optical adhesive, thereby fixing the wavelength selecting optical filter in the above-described groove. This provides a polymer optical waveguide device, having a wavelength selecting optical device bonded thereto capable of reflecting light with a wavelength of 1.3 μm and transmitting only light with a wavelength of 0.85 μm to the core portion present in the back surface of the filter. Further, the loss of light of the waveguide after wavelength selection is 1.5 dB.

### Example 2

A polymer optical waveguide is fabricated as in Example 1 with the exception that the hardness of the cured resin layer as the mold is 80 in terms of shore A hardness. In addition, the hardness of the silicone rubber material, the cured resin layer, is adjusted by the amount of a ceramic ultra fine powder that is added to the aforementioned liquid dimethylsiloxane rubber.

Of the five resulting core portions, the mean wave guide loss of three optical waveguide core portions is 1.8 dB/cm; no optical guide waves can be confirmed for the other two.

Next, a groove is produced in the waveguide base material as in Example 1 and a wavelength selecting optical filter is bonded thereto. The result is that the loss of light after wavelength selection in the three core portions that have confirmed the aforementioned optical guide waves is 5.9 dB.

### Example 3

A polymer optical waveguide is fabricated as in Example 1 with the exception that the hardness of the cured resin layer as the mold is 30 in terms of shore A hardness. The mean guide wave loss of the polymer optical waveguide is 0.15 dB/cm.

Next, a groove having a mean width of 1.15 mm is formed to a length of 20 mm on the waveguide base material so as to cut the core portions, at an angle of 45 degrees relative to the waveguide base material surface, as shown in FIGS. 7B and 7C, by dicing by means of a dicer apparatus having a dicer blade of a thickness of 1.0 mm. Then, into this groove a wavelength selecting optical filter with a thickness of 0.5 mm that reflects light having a wavelength of 1.3 μm and transmits light having a wavelength of 0.85 μm is inserted, and the optical filter is positioned in such a way that the maximum void width between the cut core portion ends and the optical pathway portions of the wavelength selecting optical filter is 0.90 mm (mean void width: 0.65 mm).

Next, a groove is produced in the waveguide base material as in Example 1 and a wavelength selecting optical filter is bonded thereto. As a result, a polymer optical waveguide device is obtained that has a loss of light of 4.2 dB after wavelength selection.

### Example 4

A polymer optical waveguide is fabricated as in the fabrication of the polymer optical waveguide of Example 3. The mean waveguide loss of the polymer optical waveguide is 0.17 dB/cm.

Next, a groove having a mean width of 0.53 mm is formed to a length of 25 mm on the waveguide base material so as to cut the core portions, at an angle of 45 degrees relative to the waveguide base material surface, as shown in FIGS. 7B and 7C, by dicing by means of a dicer apparatus having a dicer blade of a thickness of 0.5 mm. Then, into this groove a wavelength selecting optical filter with a thickness of 0.5 mm that reflects light having a wavelength of 1.3 μm and transmits light having a wavelength of 0.85 μm is inserted, and the optical filter is positioned in such a way that the maximum void width between the cut core portion ends and the optical pathway portions of the wavelength selecting optical filter is 0.10 mm (mean void width: 0.06 mm).

Next, a groove is produced in the waveguide base material as in Example 1 and a wavelength selecting optical filter is bonded thereto. As a result, a polymer optical waveguide device is obtained that has a loss of light of 3.2 dB after wavelength selection.

### Example 5

Production of a Mold

An ultraviolet ray curing thick film resist solution (trade name: SU-8, manufactured by Micro Chemical Inc.) is applied to the surface of a silicon wafer base material by spin coating and the resulting material is pre-baked in a heating oven at 80° C. The resulting material is exposed to light by use of a high pressure mercury lamp through a photomask, and after passage through a developing process, 10 fine convex portions having the cross-section of a square (width: 80 μm, height: 80 μm, pitch: 1 mm, length: 100 mm) are formed and the resulting portions are post baked at 120° C. On an end of each of the convex portions thus fabricated is formed a convex portion for producing pressure reducing voids, having the cross-section of a rectangle with a height of 2 mm, a width (in the direction perpendicular to the convex portion) of 10 mm, and a length of 20 mm in the base material length direction, to fabricate a matrix.

Next, an aluminum reinforcing member as illustrated in FIG. 5A and a glass photo-exposing opening portion 24a are produced, and 10 concave portions (width: 150 μm, height: 150 μm, pitch: 1 mm, length: 100 mm) having a shape similar to the concave portions correspondent to the convex portions are patterned at the same pitch as the above-described matrix by a photolithographic process and an etching process on an acrylic transparent rigid base material, and the resulting, latter material is integrated with the reinforcing member.

Then, to the surface of the above-described matrix is applied a thermosetting silicone rubber oligomer (trade name: SYLGARD® 184, dimethylpolysiloxane, manufactured by Dow Corning Asia Ltd.) in such a way that one end of the convex portion in the length direction is partially exposed and the convex portion for producing the void portion at the other end is covered to the end thereof. On the resulting material is pressed the aforementioned integrated reinforcing member, which is fixed thereto. Thereafter, the resultant material is heated to be hardened at 135° C. for 18 minutes, thereby integrating the silicone rubber (the cured resin layer) with the reinforced member. Subsequently, these are removed from the matrix to obtain a mold.

The silicone rubber layer of the mold includes the 80 square μm concave portions, the entry portion and discharge portion of the core forming curing resin, and the void portions. Additionally, regarding the physical properties of the silicone rubber material (the cured resin layer) at this time, the hardness is 14 in terms of shore A hardness, the surface energy is 18 mN/m, the mean rubber thickness is 5 mm, and the arithmetic mean roughness Ra of the concave produced is 0.03 μm.

Formation of a Core Portion and an Upper Cladding Layer

The above-described integrated rubber mold is pressure attached to a nonmolded surface of the electric circuit portion (conductive layer pattern) of a heat resistant transparent resin film (trade name: ARTON® FILM, shown supra, thickness: 250 μm, refractive index: 1.51). To each of the injection port and the discharge port of the above-described rubber mold are also connected an injection tube and a pressure reducing degassing tube. The injection tube is communicated to a pressure tank in which the core forming curing resin is placed, and further a nitrogen cylinder is directly connected to the pressure tank, thereby enabling pressure injection of the resin at a static pressure. Moreover, the pressure reducing degassing tube is communicated with a vacuum pump via a pressure control mechanism and pressure reducing tank such that pressure reducing aspiration is carried out by means of a static pressure that is pressure adjusted.

An ultraviolet ray curing resin having a viscosity of 500 mPa.s is pressure-reduction injected into the rubber mold concave portion while simultaneously conducting pressurization and aspiration by static pressure. After the completion of filling, the injection tube and pressure reducing degassing tube are removed from the rubber mold, and then the core forming curing resin is hardened by irradiation with a UV ray having a light intensity of 80 mW/cm² for 8 minutes through the quartz window of the rubber mold. Upon release of the mold, a core portion with a refractive index of 1.53 on the film is formed.

After a thermosetting resin having, subsequent to curing, a refractive index of 1.51 that is equivalent to that of the film is applied to the entire molded surface of the film core portion, the resin is heat hardened to obtain a flexible polymer optical waveguide. The mean wave guide loss of the polymer optical waveguide is 0.13 dB/cm, indicating that the polymer optical waveguide exhibits good waveguiding of light to the optical waveguide as in Example 1.

Formation of a Groove, Insertion and Positioning of an Optical Device and Optical Bonding

Next, the waveguide base material is subjected to a punch processing procedure using a Thomson blade, thereby forming a punched space having an area of 10.7 mm×5.1 mm in the center of the waveguide base material as shown in FIG. 6B. Then, this waveguide base material is adhered to a smooth quartz rigid base material having a thickness of 1 mm and a surface arithmetic mean roughness Ra of 0.1 μm, as shown in FIG. 6C. Then, an optical switch device (area: 9.9 mm×4.8 mm, thickness: 1 mm) is put in the aforementioned punched space, and the position is determined such that the maximum void width between the cut core portion end and the optical pathway portion of the optical switch device is 0.08 mm.

Thereafter, an ultraviolet ray curing optical adhesive that has a refractive index of 525, and transmits light having wavelengths of 0.85 μm and 1.3 μm at 90%/mm is injected into the space between the optical device and the core portion end. Then, the optical adhesive is irradiated with an ultraviolet ray of 360 nm and cured, and subsequently the optical device is fixed in the aforementioned groove to fabricate a polymer optical waveguide device. To this device is introduced light with a wavelength of 0.85 μm, and the optical switch is on, showing that light which is optical-switch controlled with an optical splice loss of 1.3 dB can be wave guided.

### Comparative Example 1

SiO₂ material containing germania (germanium dioxide) as a core material layer is deposited to a thickness of 30 μm on a quartz base material by vacuum deposition, and the core material layer of an unnecessary portion free of the waveguide is removed by a photolithographic method to form a waveguide core portion having a length of 100 mm as a linear pattern portion. Then, the entire surface of the base material is coated with SiO₂ by vacuum deposition, thereby forming a cladding layer portion. Subsequently, ends of the base material are cut by means of a dicing apparatus and then the resulting ends are ground with diamond particles, thereby fabricating an optical waveguide device having a core portion made of an inorganic material.

The optical waveguide loss of this optical waveguide device is large, at 3.3 dB/cm; this is due to the fact that the arithmetic mean roughness Ra of the core side surface is 0.45 μm, attributable to etching in the aforementioned photolithographic process. For the insertion of a wavelength selecting optical filter, the processing of producing a groove is carried out by a grinding cutting apparatus, which produces pitching in the base material causing the maximum void width between the groove and the optical filter to be 0.6 mm. This renders the loss of light of the optical filter portion equal to 6.5 dB, thus not obtaining good performance.

What is claimed is:

1. A method for fabricating a polymer optical waveguide device, comprising:
(1) preparing a mold including a cured resin layer of a mold forming curing resin and having a concave portion correspondent to a core portion of an optical waveguide formed therein;
(2) attaching the mold to a cladding base material;
(3) filling the concave portion of the mold with a core forming curing resin;
(4) hardening the core forming curing resin to form a cured core portion;
(5) forming a space or a groove for placing an optical device in a middle part in the waveguide direction of the core portion such that the optical device cuts across the core portion;
(6) inserting and positioning the optical device in a predetermined position of the space or groove; and
(7) conducting an optical bonding between an optical pathway portion of the optical device and the core portion.

2. The method of claim 1, wherein forming the space or groove comprises forming the space or groove so as to have a length, in the waveguide direction, which is about 3 μm to about 5 mm longer than the length of the optical device in the waveguide direction.

3. The method of claim 1, wherein forming the space or groove comprises forming the space or groove by means of a dicer apparatus.

4. The method of claim 1, wherein forming the space or groove comprises forming the space or groove so as to penetrate the core portion as far as the cladding base material, and attaching a rigid base material having a surface arithmetic mean roughness Ra ranging from about 20 nm to about 2 μm, as an underlying material, to a surface opposite to a surface on which the core portion of the cladding base material is patterned, before inserting the optical device into the space or groove.

5. The method of claim 1, wherein inserting and positioning the optical device comprises positioning the optical device in such a way that the maximum void width between the optical pathway portion of the optical device and an end surface of the cut across core portion is about 0.4 mm or less, after inserting the optical device into the space or groove.

6. The method of claim 1, wherein the optical bonding comprises fixing the optical device which is positioned in the space or groove.

7. The method of claim 6, wherein fixing the optical device comprises filling the space between the optical device and the core portion with an optical adhesive which has a refractive index difference to the core portion of about ±0.2 or less between the adhesive and the core portion, and then fixing the optical device by solidifying the optical adhesive.

8. The method of claim 7, wherein the refractive index difference of the optical adhesive to the core portion is about ±0.1 or less, and wherein the optical transmittance of the optical adhesive is 90%/mm or more in the wavelength range of light used.

9. The method of claim 1, wherein the optical device uses at least one selected from the group consisting of an optical filter, an optical lens, an optical mirror, an optical switch, a light emitting device and a light receiving device.

10. The method of claim 1, wherein inserting and positioning the optical device comprises using a wavelength selecting optical filter as the optical device, and inserting and positioning the wavelength selecting optical filter such that the wavelength selecting optical filter has an incidence angle of within about 55°±35° relative to the wave guide direction of the core portion.

11. The method of claim 10, further comprising forming a core portion for reflecting light which guides light reflected by the wavelength selecting optical filter such that the core portion for reflecting light is within about ±10° of the incidence angle, relative to the optical wavelength selecting filter surface, and optically bonding.

12. The method of claim 1, wherein the cured resin layer comprises silicon rubber.

13. The method of claim 1, wherein the thickness of the cured resin layer ranges from about 5 μm to about 5 mm.

14. The method of claim 1, wherein the shore A hardness of the cured resin layer ranges from about 10 to about 50.

15. The method of claim 1, wherein the surface energy of the cured resin layer ranges from about 7 to about 30 mN/m.

16. The method of claim 1, wherein the surface arithmetic mean roughness Ra of the concave portion in the cured resin layer ranges from about 0.01 to about 0.1 μm.

17. The method of claim 1, wherein the cladding base material comprises at least one selected from the group consisting of a ceramic base material, a glass base material, a film base material and a silicone wafer.

18. The method of claim 1, wherein preparing the mold comprises providing the cured resin layer with an entry port and discharge port, and wherein attaching the mold to the cladding base material comprises integrally attaching, to the cladding base material, the mold and a reinforcing member which reinforces the cured resin layer and has an injection port for pressure introducing the core forming curing resin.

19. The method of claim 18, wherein the reinforcing member is selected from the group consisting of a metal material, a ceramic material and a plastic material.

20. The method of claim 1, wherein filling the core forming curing resin comprises pressure filling the core forming curing resin into an entry portion of the concave portion of the mold, and also reduction-pressure aspirating the resin from a discharge portion of the concave portion of the mold.
